(19) United States
(12) Patent Application Publication
(10) Pub. No.: US 2018/0115805 A1
(43) Pub. Date: Apr. 26, 2018

(54) Networked One-Touch Configurable Audio-Visual Devices

(71) Applicant: Libre Wireless Technologies Inc., Irvine, CA (US)

(72) Inventors: Hooman Kashef, Coto de Caza, CA (US); Hari Bojan, Bangalore (IN); Jordan Watters, Spicewood, TX (US)

(21) Appl. No.: 15/332,280

(22) Filed: Oct. 24, 2016

(51) Int. Cl. H04N 21/485; H04N 21/436; H04N 21/44; H04N 21/439; H04L 12/24; H04N 21/422; H04W 76/02

(52) U.S. Cl. CPC H04N 21/485; H04N 21/436; H04N 21/44; H04W 84/12; H04L 41/08; H04N 21/42204; H04W 76/023; H04N 21/439

(57) ABSTRACT

There are disclosed herein implementations of a method for networking audio-visual devices for substantially synchronous delivery of audio-visual content, as well as a network including audio-visual devices configured for such use. Each of the audio-visual devices has situated thereon a respective group owner switch and a respective client switch. The method includes designating one of the audio-visual devices as a group owner by turning on the group owner switch situated on the audio-visual device. The method further includes designating at least another of the audio-visual devices as a client by turning on its respective client switch, thereby forming a network between the group owner and the client for the substantially synchronous delivery of the audio-visual content.

### RELATED APPLICATION(S)

The present application is related to U.S. patent application Ser. No. 15/332,188, filed on Oct. 24, 2016, Attorney Docket Number 0660101, and titled “Dynamic Direct Multinode (DDM) Wireless Network.” The disclosure of this related application is hereby incorporated fully by reference into the present application.

### BACKGROUND

Home networking of wireless devices is a popular and increasingly commonplace practice. For example, multi-room audio systems are used to play music throughout a home, as well as in outdoor areas adjacent to the home, such as a pool area, patio, or backyard. In addition, multi-room video systems may be used to establish home theaters capable of delivering audio and video content to video displays in several locations in a home.

However, one drawback of conventional multi-room networking solutions is the complexity associated with setting up and configuring the network. For example, conventional user instructions for establishing multi-room audio or video networks require the user to utilize a network setup software application (e.g., an “app”) executed by a computing device such as a smart remote, smartphone, or tablet computer. Those network setup applications are often complicated, requiring a user to navigate among multiple control screens, and in many situations require a user to be technology savvy to utilize them successfully.

Moreover, some users may encounter difficulty in even running the software applications required for network setup, especially users who may retain and continue to use personal computing devices that are approaching obsolescence. For example, limited device memory of older computing devices or incompatibility between a network setup application and an older device's operating system may present further obstacles to enjoyment of multi-room audio and video.

Thus, there is a need in the art for a network setup solution that enables a user to establish and enjoy a multi-room home network without needing or mastering a network setup software application.

### SUMMARY

The present disclosure is directed to networked one-touch configurable audio-visual devices, substantially as shown in and/or described in connection with at least one of the figures, and as set forth in the claims.

### BRIEF DESCRIPTION OF THE DRAWINGS

FIG. 1 shows an exemplary network including one-touch configurable audio-visual devices, according to one implementation.

FIG. 2A shows an exemplary one-touch configurable audio-visual device suitable for use as a network group owner or a network client, according to one implementation.

FIG. 2B shows an exemplary one-touch configurable audio-visual device suitable for use as a network client or a network group owner, according to one implementation.

FIG. 3 shows an exemplary network including one-touch configurable audio-visual devices, according to another implementation.

FIG. 4 shows an exemplary network including one-touch configurable audio-visual devices, according to yet another implementation.

FIG. 5 shows a flowchart presenting an exemplary method for networking one-touch configurable audio-visual devices.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, home networking of wireless devices is a popular and increasingly commonplace practice. For example, multi-room audio systems are used to play music throughout a home, as well as in outdoor areas adjacent to the home, such as a pool area, patio, or backyard. In addition, multi-room video systems may be used to establish home theaters capable of delivering audio and video content to video displays in several locations in a home.

However, and as further stated above, one drawback of conventional multi-room networking solutions is the complexity associated with setting up and configuring the network. For example, conventional user instructions for establishing multi-room audio or video networks require the user to utilize a network setup software application (e.g., an “app”) executed by a computing device such as a smart remote, smartphone, or tablet computer. Those network setup applications are often complicated, requiring a user to navigate among multiple control screens, and in many situations require a user to be technology savvy to utilize them successfully.

The present application discloses networked one-touch configurable audio-visual devices, and methods for networking such one-touch configurable audio-visual devices to provide substantially synchronous delivery of audio-visual content. The various networked one-touch configurable audio-visual devices and the networking methods disclosed in the present application advantageously enable a user, such as a technology novice, to establish and enjoy a multi-room home network without needing or mastering a complicated network setup software application (e.g., an “app”).

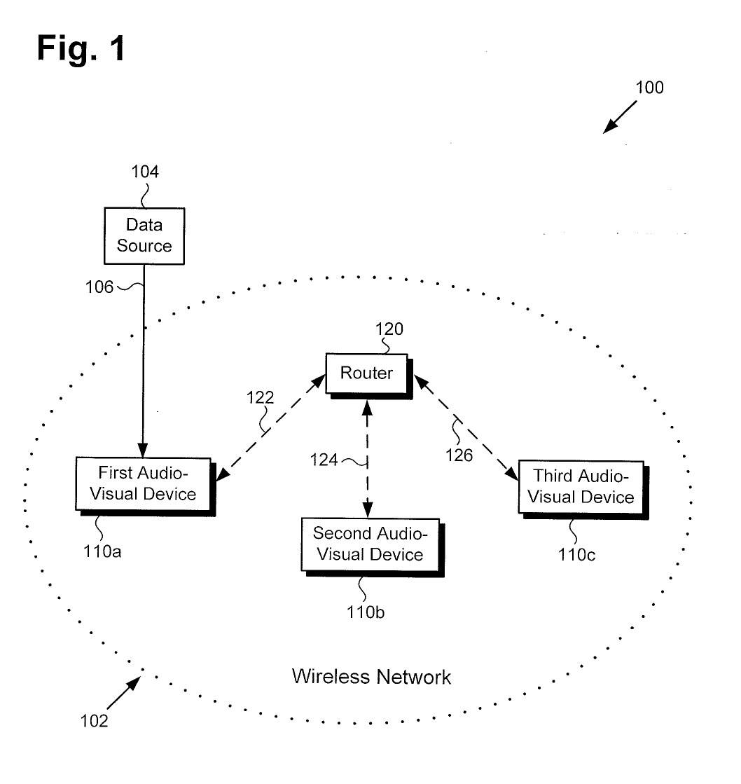

FIG. 1 shows communication enviromnent 100 including exemplary wireless network 102 including multiple one-touch configurable audio-visual devices, according to one implementation. It is noted that for the purposes of the present disclosure, an audio-visual device may be any device capable of outputting audio and/or video content. In other words, audio-visual devices may include audio speakers, video displays, digital media players, and gaming consoles, to name a few examples.

As shown in FIG. 1, communication enviromnent 100 includes external data source 104, which may correspond to the Internet, any public or private network of remote servers (hereinafter referred to as “the cloud”), or a set-top box for providing cable, satellite, or streaming media, for example. Communication environment 100 also includes wireless network 102 having first audio-visual device 110a, second audio-visual device 110b, third audio-visual device 110c, and router 120 providing wireless communication links 122, 124, and 126.

As also shown in FIG. 1, according to the present exemplary implementation, first audio-visual device 110a of wireless network 102 is configured to receive audio-visual content 106 from external data source 104. Audio-visual content 106 may include audio and/or video content, and thus may be music content, television content, or movie content, to name a few examples.

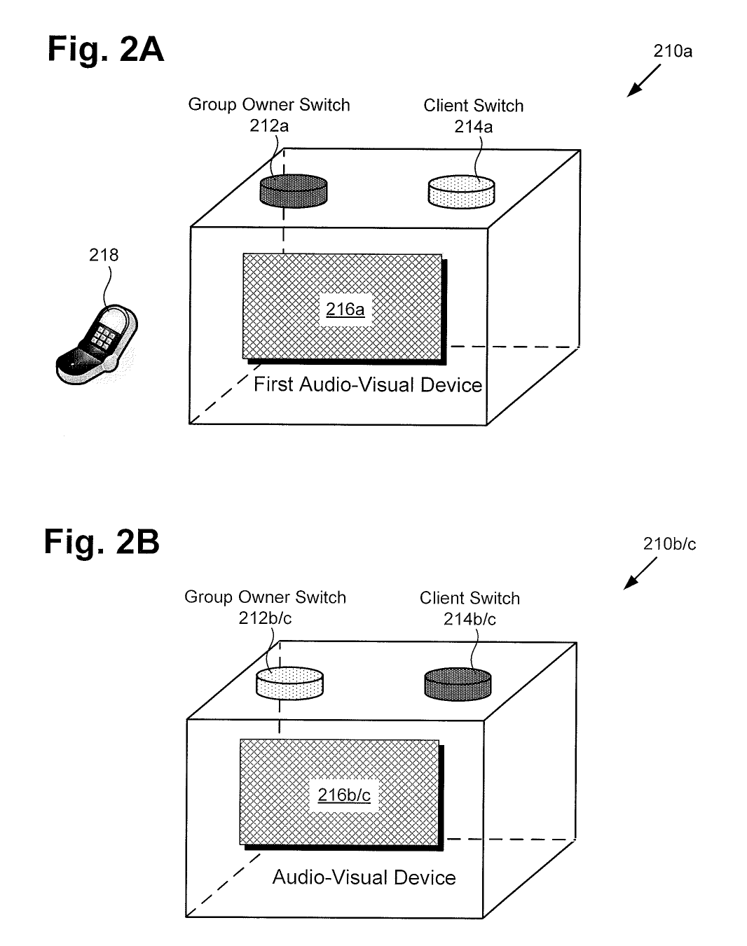

It is noted that although the exemplary implementation shown in FIG. 1 depicts first audio-visual device 110a as receiving audio-visual content 106, in other implementations, any one of first audio-visual device 110a, second audio-visual device 110b, and third audio-visual device 110c may be configured to receive audio-visual content 106. It is further noted that audio-visual content 106 may be received from external data source 104 via a wireless connection with external data source 104, or via a wire connection from external data source 104. As shown in greater detail by subsequent FIGS. 2A and 2B each of first audio-visual device 110a, second audio-visual device 110b, and third audio-visual device 110c has situated thereon a respective group owner switch and a respective client switch (group owner switches and client switches not visible in FIG. 1). As a result, each of first audio-visual device 110a, second audio-visual device 110b, and third audio-visual device 110c can be designated as a group owner of wireless network 102 by turning on its respective group owner switch.

Furthermore, each of first audio-visual device 110a, second audio-visual device 110b, and third audio-visual device 110c can be designated as a client by turning on its respective client switch. In other words, each of first audio-visual device 110a, second audio-visual device 110b, and third audio-visual device 110c can be utilized as a one-touch configurable audio-visual device. According to the exemplary implementation shown in FIG. 1, first audio-visual device 110a has been designated as the group owner, while second audio-visual device 110b and third audio-visual device 110c have been designated as clients.

Moreover, according to the exemplary implementation shown in FIG. 1, router 120, which may include a wireless access point (WAP), for example, provides the communication infrastructure for wireless network 102. That is to say, according to the implementation of exemplary wireless network 102, router 120 provides the routing functions for establishing and maintaining wireless communication links 122, 124, and 126 between group owner first audio-visual device 110a and client second and third audio-visual devices 110b and 110c. Thus, router 120 routes audio-visual content 106 from group owner first audio-visual device 110a to client second and third audio-visual devices 110b and 110c.

Wireless communication links 122, 124, and 126 between group owner first audio-visual device 110a and client second and third audio-visual devices 110b and 110c may be provided using any suitable wireless communications methods. For example, the wireless communication between group owner first audio-visual device 110a and client second and third audio-visual devices 110b and 110c, may be performed via one or more of WiFi, Bluetooth, ZigBee, and 60 GHz wireless communications methods.

Wireless network 102 between group owner first audio-visual device 110a and client second and third audio-visual devices 110b and 110c is formed when the group owner switch of first audio-visual device 110a and the respective client switches of second and third audio-visual devices 110b and 110c are turned on. It is noted that wireless network 102 between group owner first audio-visual device 110a and client second and third audio-visual devices 110b and 110c is configured for substantially synchronous delivery of audio-visual content 106 to a user or users of wireless network 102. It is further noted that, in contrast to conventional Wi-Fi Protected Setup (WPS) protocols, group owner first audio-visual device 110a can connect with two or more client audio-visual devices, such as client second and third audio-visual devices 110b and 110c, substantially concurrently.

First audio-visual device 110a, second audio-visual device 110b, and third audio-visual device 110c may be implemented as multiple instances of a substantially identical audio-visual device, such as multiple audio speakers, for example. However, in some implementations, one or more of first audio-visual device 110a, second audio-visual device 110b, and third audio-visual device 110c may differ from others of first audio-visual device 110a, second audio-visual device 110b, and third audio-visual device 110c. That is to say, in some implementations, first audio-visual device 110a, second audio-visual device 110b, and third audio-visual device 110c may correspond to two or more different types of audio-visual devices. As a specific example of such an implementation, first audio-visual device 110a may be a home theater system including a video display, while second audio-visual device 110b and third audio-visual device 110c may be remote audio speakers for providing surround sound or multi-room audio effects for the home theater.

Furthermore, although the implementation shown in FIG. 1 depicts wireless network 102 as including three audio-visual devices, that representation is provided merely for conceptual clarity. In practice, wireless network 102 may include more, or many more, than three audio-visual devices, such as ten, twenty, thirty, or more audio-visual devices.

With respect to relative placement of audio-visual devices such as first audio-visual device 110a, second audio-visual device 110b, and third audio-visual device 110c, some or all of those audio-visual devices may be situated relatively close to one another, such as being in the same room, or one or more of first audio-visual device 110a, second audio-visual device 110b, and third audio-visual device 110c may be situated in a different room from the others. Moreover, in some implementations, one or more of first audio-visual device 110a, second audio-visual device 110b, and third audio-visual device 110c may be situated indoors, while others of first audio-visual device 110a, second audio-visual device 110b, and third audio-visual device 110c may be situated outdoors. For some applications, such as network media and audio streaming applications, for example, it may be advantageous or desirable for first audio-visual device 110a, second audio-visual device 110b, and third audio-visual device 110c to operate on substantially the same time-base relative to each other and with very accurate timing control and timing resolution. According to the implementation of exemplary wireless network 102 shown in FIG. 1, group owner first audio-visual device 110a can provide timing and/or phase synchronization for client second and third audio-visual devices 110b and 110c. For example, group owner first audio-visual device 110a may track and take into account the overall delay and jitter in wireless network 102, and may run a closed loop time and phase lock tracking function to provide synchronization between first audio-visual device 110a, second audio-visual device 110b, and third audio-visual device 110c.

FIG. 2A shows a more detailed representation of first audio-visual device 210a configured for use as a group owner (or a client), according to one implementation. As shown in FIG. 2A, first audio-visual device 210a includes group owner switch 212a and client switch 214a situated thereon. Also shown in FIG. 2A are optional touchscreen 216a of first audio-visual device 210a, and optional remote control 218.

First audio-visual device 210a corresponds in general to first audio-visual device 110a, in FIG. 1, and may share any of the characteristics attributed to that corresponding feature in the present application. Moreover, in so far as any one of first audio-visual device 110a, second audio-visual device 110b, and third audio-visual device 110c is configurable to serve as a group owner (or a client) of wireless network 102, first audio-visual device 210a can also correspond in general to either of second audio-visual device 110b or third audio-visual device 110c in FIG. 1.

As shown in FIG. 2A, group owner switch 212a is depicted as a darker feature than control switch 214a to indicate that group owner switch 212a of first audio-visual device 210a has been turned on, while client switch 214a of first audio-visual device 210a remains off. As a result, first audio-visual device 210a has been designated as a network group owner, for example, a group owner of wireless network 102.

It is noted that, for the purposes of the present application, the feature described as a group owner or control switch may take several distinct forms. Thus, group owner switch 212a and client switch 214a may take the form of a toggle switch, or a button, for example, such as the push button implementations shown in FIG. 2A. It is further noted that in some implementations, group owner switch 212a and client switch 214a may be turned on using touchscreen 216a of first audio-visual device 210a, or using remote control 218.

FIG. 2B shows a more detailed representation of audio-visual device 210b/c configured for use as a client, according to one implementation. As shown in FIG. 2B, audio-visual device 210b/c includes group owner switch 212b/c and client switch 214b/c situated thereon. Also shown in FIG. 2B is optional touchscreen 216b/c of audio-visual device 210b/c.

Audio-visual device 210b/c corresponds in general to second and third audio-visual devices 110b and 110c, in FIG. 1, and may share any of the characteristics attributed to those corresponding features in the present application. Moreover, in so far as any one of first audio-visual device 110a, second audio-visual device 110b, and third audio-visual device 110c is configurable to serve as a client (or a group owner) of wireless network 102, audio-visual device 210b/c can also correspond in general to first audio-visual device 110a in FIG. 1. As shown in FIG. 2B, client switch 214b/c is depicted as a darker feature than group owner switch 212b/c to indicate that client switch 214b/c of audio-visual device 210b/c has been turned on, while group owner switch 212b/c of audio-visual device 210b/c remains off. As a result, audio-visual device 210b/c has been designated as a network client, such as a client of wireless network 102.

Group owner switch 212b/c and client switch 214b/c correspond respectively in general to group owner switch 212a and client switch 214a, in FIG. 2A, and may share any of the characteristics attributed to those corresponding features in the present application. That is to say, like group owner switch 212a and client switch 214a, group owner switch 212b/c and client switch 214b/c may take the form of a toggle switch, or a button, for example, such as the push button implementations shown in FIG. 2B.

Furthermore, in some implementations, group owner switch 212b/c and client switch 214b/c may be turned on using touchscreen 216b/c of audio-visual device 210b/c, or using remote control 218, shown in FIG. 2A. It is noted that remote control 218 may be usable to control all audio-visual devices within a network, such as first audio-visual device 110a, second audio-visual device 110b, and third audio-visual device 110c of wireless network 102, in FIG. 1, for example.

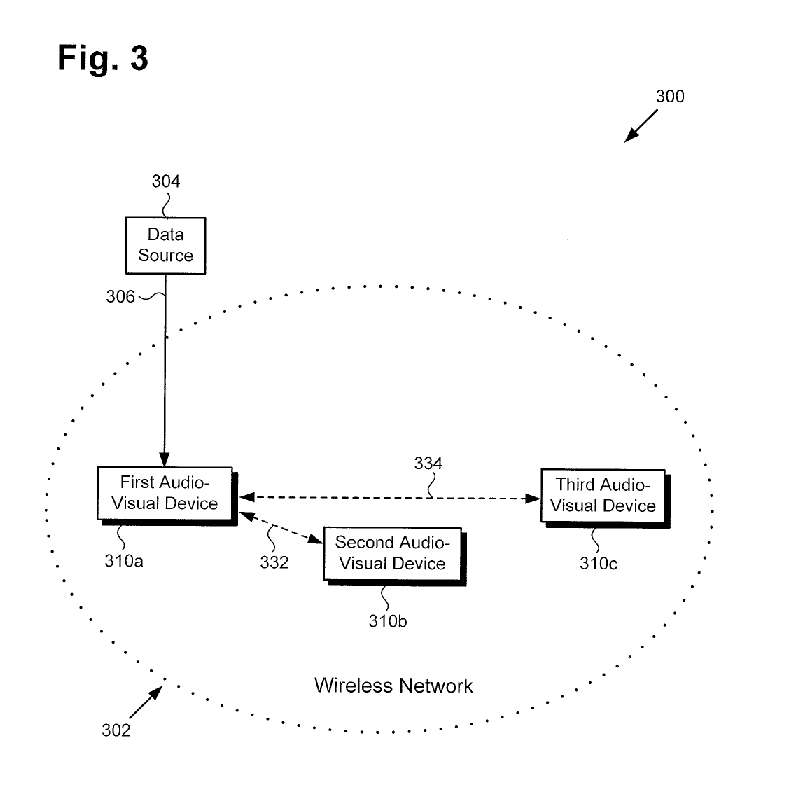

FIG. 3 shows communication environment 300 including exemplary wireless network 302 including multiple one-touch configurable audio-visual devices, according to another implementation. It is reiterated that, as used herein, an audio-visual device may be any device capable of outputting audio and/or video content. In other words, audio-visual devices may include audio speakers, video displays, digital media players, and gaming consoles, to name a few examples.

As shown in FIG. 3, communication environment 300 includes external data source 304, audio-visual content 306, and wireless network 302 having first audio-visual device 310a, second audio-visual device 310b, third audio-visual device 310c, and wireless communication links 332 and 334. External data source 304 and audio-visual content 306 correspond respectively in general to external data source 104 and audio-visual content 106, in FIG. 1, and may share any of the characteristics attributed to those corresponding features in the present application.

First audio-visual device 310a corresponds in general to first audio-visual device 210a, in FIG. 2A, and may share any of the characteristics attributed to that corresponding feature in the present application. In other words, first audio-visual device 310a has situated thereon a group owner switch corresponding to group owner switch 212a and a client switch corresponding to client switch 214a. Moreover, the group owner switch of first audio-visual device 310a is turned on, designating first audio-visual device 310a as group owner of wireless network 302.

Second audio-visual device 310b and third audio-device 310c correspond in general to audio-visual device 210b/c, in FIG. 2B, and may share any of the characteristics attributed to that corresponding feature in the present application. In other words, second audio-visual device 310b and third audio-visual device 310c have situated thereon respective group owner switches corresponding to group owner switch 212b/c and client switches corresponding to client switch 214b/c. Moreover, the respective client switches of second audio-visual device 310b and third audio-visual device 310c are turned on, designating second audio-visual device 310b and third audio-visual device 310c as clients of wireless network 302.

As also shown in FIG. 3, according to the present exemplary implementation, first audio-visual device 310a of wireless network 302 is configured to receive audio-visual content 306 from external data source 304. It is noted that although the exemplary implementation shown in FIG. 3 depicts first audio-visual device 310a as receiving audio-visual content 306, in other implementations, any one of first audio-visual device 310a, second audio-visual device 310b, and third audio-visual device 310c may be configured to receive audio-visual content 306. It is further noted that audio-visual content 306 may be received from external data source 304 via a wireless connection with external data source 304, or via a wire connection from external data source 304.

In some implementations, wireless network 302 may be a dynamic direct multinode (DDM) network. It is noted that, as used in the present application, the term “dynamic direct multinode” and its acronym “DDM” define a wireless network that is “dynamic” and “multinode” because the number and functionality of multiple audio-visual devices serving as nodes of the network can be altered dynamically. That is to say, audio-visual devices corresponding to first audio-visual device 310a, second audio-visual device 310b, and third audio-visual device 310c may be added to or removed from wireless network 302 on the fly.

Moreover, a DDM wireless network is “direct” because the audio-visual device configured as the group owner, i.e., first audio-visual device 310a, and the audio-visual device or devices configured as a client or clients, i.e., second audio-visual device 310b and third audio-visual device 310c, are configured to communicate directly. That is to say, group owner first audio-visual device 310a communicates directly with each of client second and third audio-visual devices 310b and 310c via respective direct wireless communication links 332 and 334, without first routing such communications through an intermediary device, such as router 120, in FIG. 1.

The direct wireless communication between group owner first audio-visual device 310a and respective client second and third audio-visual devices 310b and 310c provided by direct wireless communication links 332 and 334 advantageously enables establishment of a consistent, accurate, and efficient network connectivity. As a result, wireless network 302 conserves network capacity, and reduces network traffic load, buffering, delay, and jitter when compared to wireless network architectures in which network communication traffic passes through a router.

Wireless communication links 332 and 334 between group owner first audio-visual device 310a and respective client second and third audio-visual devices 310b and 310c may be provided using any suitable wireless communications methods. For example, the wireless communication between group owner first audio-visual device 310a and client second and third audio-visual devices 310b and 310c, may be performed via one or more of WiFi, Bluetooth, ZigBee, and 60 GHz wireless communications methods.

Wireless network 302 between group owner first audio-visual device 310a and client second and third audio-visual devices 310b and 310c is formed when the group owner switch of first audio-visual device 310a and the respective client switches of second and third audio-visual devices 310b and 310c are turned on. It is noted that wireless network 302 between group owner first audio-visual device 310a and client second and third audio-visual devices 310b and 310c is configured for substantially synchronous delivery of audio-visual content 306 to a user or users of wireless network 302. It is further noted that, in contrast to conventional WPS protocols, group owner first audio-visual device 310a can advantageously connect with two or more client audio-visual devices, such as client second and third audio-visual devices 310b and 310c, substantially concurrently.

First audio-visual device 310a, second audio-visual device 310b, and third audio-visual device 310c may be implemented as multiple instances of a substantially identical audio-visual device, such as multiple audio speakers, for example. However, in some implementations, one or more of first audio-visual device 310a, second audio-visual device 310b, and third audio-visual device 310c may differ from others of first audio-visual device 310a, second audio-visual device 310b, and third audio-visual device 310c. That is to say, in some implementations, first audio-visual device 310a, second audio-visual device 310b, and third audio-visual device 310c may correspond to two or more different types of audio-visual devices. As a specific example of such an implementation, first audio-visual device 310a may be a home theater system including a video display, while second audio-visual device 310b and third audio-visual device 310c may be remote audio speakers for providing surround sound or multi-room audio effects for the home theater.

Furthermore, although the implementation shown in FIG. 3 depicts wireless network 302 as including three audio-visual devices, that representation is provided merely for conceptual clarity. In practice, wireless network 302 may include more, or many more, than three audio-visual devices, such as ten, twenty, thirty, or more audio-visual devices.

With respect to relative placement of audio-visual devices such as first audio-visual device 310a, second audio-visual device 310b, and third audio-visual device 310c, some or all of those audio-visual devices may be situated relatively close to one another, such as being in the same room, or one or more of first audio-visual device 310a, second audio-visual device 310b, and third audio-visual device 310c may be situated in a different room from the others. Moreover, in some implementations, one or more of first audio-visual device 310a, second audio-visual device 310b, and third audio-visual device 310c may be situated indoors, while others of first audio-visual device 310a, second audio-visual device 310b, and third audio-visual device 310c may be situated outdoors.

For some applications, such as network media and audio streaming applications, for example, it may be advantageous or desirable for first audio-visual device 310a, second audio-visual device 310b, and third audio-visual device 310c to operate on substantially the same time-base relative to each other and with very accurate timing control and timing resolution. According to the implementation of exemplary wireless network 302 shown in FIG. 1, group owner first audio-visual device 310a can provide timing and/or phase synchronization for client second and third audio-visual devices 310b and 310c. For example, group owner first audio-visual device 310a may track and take into account the overall delay and jitter in wireless network 302, and may run a closed loop time and phase lock tracking function to provide synchronization between first audio-visual device 310a, second audio-visual device 310b, and third audio-visual device 310c.

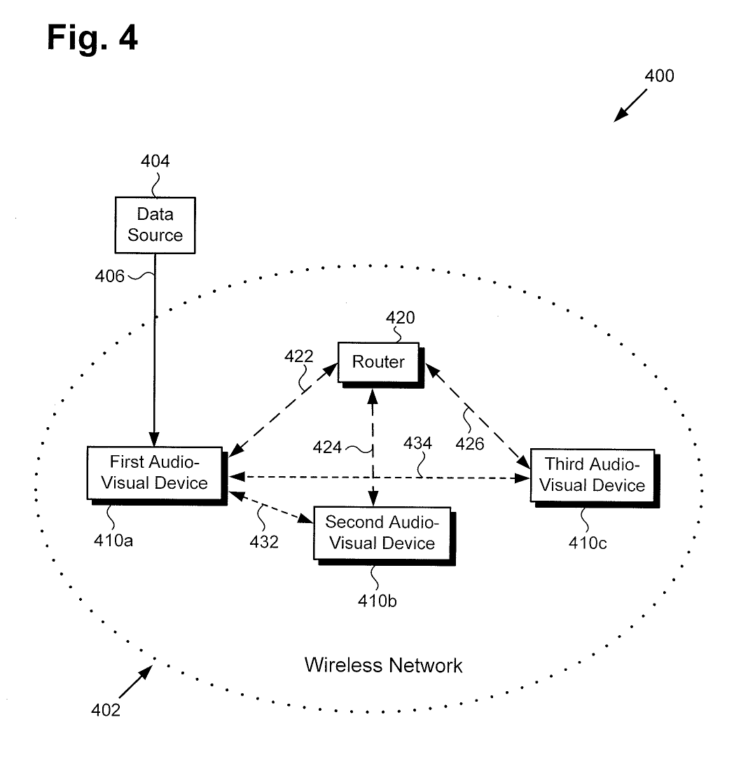

FIG. 4 shows communication environment 400 including exemplary wireless network 402 including multiple one-touch configurable audio-visual devices, according to yet another implementation. It is reiterated that, as used herein, an audio-visual device may be any device capable of outputting audio and/or video content. In other words, audio-visual devices may include audio speakers, video displays, digital media players, and gaming consoles, to name a few examples.

As shown in FIG. 4, communication environment 400 includes external data source 404, audio-visual content 406, and wireless network 402 having first audio-visual device 410a, second audio-visual device 410b, third audio-visual device 410c, router 420, and wireless communication links 422, 424, 426, 432 and 434. External data source 404, audio-visual content 406, router 420, and wireless communication links 422, 424, and 426 correspond respectively in general to external data source 104, audio-visual content 106, router 120, and wireless communication links 122, 124, and 126, in FIG. 1, and may share any of the characteristics attributed to those corresponding features in the present application.

Moreover, wireless communication links 432 and 434 are shown as direct wireless communication links between first audio-visual device 410 and respective second and third audio-visual devices 410b and 410c, and correspond respectively in general to direct wireless communication links 332 and 334, in FIG. 3. Thus, wireless communication links 432 and 434 may share any of the characteristics attributed to corresponding direct wireless communication links 332 and 334 in the present application. For example, communication over wireless communication links 432 and 434 may be performed via one or more of WiFi, Bluetooth, ZigBee, and 60 GHz wireless communications methods.

First audio-visual device 410a corresponds in general to first audio-visual device 210a, in FIG. 2A, and may share any of the characteristics attributed to that corresponding feature in the present application. In other words, first audio-visual device 410a has situated thereon a group owner switch corresponding to group owner switch 212a and a client switch corresponding to client switch 214a. Moreover, the group owner switch of first audio-visual device 410a is turned on, designating first audio-visual device 410a as group owner of wireless network 402.

Second audio-visual device 410b and third audio-device 410c correspond in general to audio-visual device 210b/c, in FIG. 2B, and may share any of the characteristics attributed to that corresponding feature in the present application. In other words, second audio-visual device 410b and third audio-visual device 410c have situated thereon respective group owner switches corresponding to group owner switch 212b/c and client switches corresponding to client switch 214b/c. Moreover, the respective client switches of second audio-visual device 410b and third audio-visual device 410c are turned on, designating second audio-visual device 410b and third audio-visual device 410c as clients of wireless network 402.

As also shown in FIG. 4, according to the present exemplary implementation, first audio-visual device 410a of wireless network 402 is configured to receive audio-visual content 406 from external data source 404. It is noted that although the exemplary implementation shown in FIG. 4 depicts first audio-visual device 410a as receiving audio-visual content 406, in other implementations, any one of first audio-visual device 410a, second audio-visual device 410b, and third audio-visual device 410c may be configured to receive audio-visual content 406. It is further noted that audio-visual content 406 may be received from external data source 404 via a wireless connection with external data source 404, or via a wire connection from external data source 404.

In some implementations, wireless network 402 may be a DDM network, as described above by reference to FIG. 3. That is to say, audio-visual devices corresponding to first audio-visual device 410a, second audio-visual device 410b, and third audio-visual device 410c may be added to or removed from wireless network 402 on the fly. Moreover, group owner first audio-visual device 410a is shown to communicate directly with each of client second and third audio-visual devices 410b and 410c via respective direct wireless communication links 432 and 434, without first routing those communications through an intermediary device, such as router 420.

The direct wireless communication between group owner first audio-visual device 410a and respective client second and third audio-visual devices 410b and 410c provided by direct wireless communication links 432 and 434 advantageously enables establishment of a consistent, accurate, and efficient network connectivity. As a result, wireless network 402 conserves network capacity, and reduces network traffic load, buffering, delay, and jitter when compared to wireless network architectures in which network communication traffic passes exclusively through router 420.

Wireless network 402 between group owner first audio-visual device 410a and client second and third audio-visual devices 410b and 410c is formed when the group owner switch of first audio-visual device 410a and the respective client switches of second and third audio-visual devices 410b and 410c are turned on. It is noted that wireless network 402 between group owner first audio-visual device 410a and client second and third audio-visual devices 410b and 410c is configured for substantially synchronous delivery of audio-visual content 406 to a user or users of wireless network 402. It is further noted that, in contrast to conventional WPS protocols, group owner first audio-visual device 410a can advantageously connect with two or more client audio-visual devices, such as client second and third audio-visual devices 410b and 410c, substantially concurrently.

First audio-visual device 410a, second audio-visual device 410b, and third audio-visual device 410c may be implemented as multiple instances of a substantially identical audio-visual device, such as multiple audio speakers, for example. However, in some implementations, one or more of first audio-visual device 410a, second audio-visual device 410b, and third audio-visual device 410c may differ from others of first audio-visual device 410a, second audio-visual device 410b, and third audio-visual device 410c. That is to say, in some implementations, first audio-visual device 410a, second audio-visual device 410b, and third audio-visual device 410c may correspond to two or more different types of audio-visual devices. As a specific example of such an implementation, first audio-visual device 410a may be a home theater system including a video display, while second audio-visual device 410b and third audio-visual device 410c may be remote audio speakers for providing surround sound or multi-room audio effects for the home theater.

Furthermore, although the implementation shown in FIG. 4 depicts wireless network 402 as including three audio-visual devices, that representation is provided merely for conceptual clarity. In practice, wireless network 402 may include more, or many more, than three audio-visual devices, such as ten, twenty, thirty, or more audio-visual devices.

With respect to relative placement of audio-visual devices such as first audio-visual device 410a, second audio-visual device 410b, and third audio-visual device 410c, some or all of those audio-visual devices may be situated relatively close to one another, such as being in the same room, or one or more of first audio-visual device 410a, second audio-visual device 410b, and third audio-visual device 410c may be situated in a different room from the others. Moreover, in some implementations, one or more of first audio-visual device 410a, second audio-visual device 410b, and third audio-visual device 410c may be situated indoors, while others of first audio-visual device 410a, second audio-visual device 410b, and third audio-visual device 410c may be situated outdoors.

For some applications, such as network media and audio streaming applications, for example, it may be advantageous or desirable for first audio-visual device 410a, second audio-visual device 410b, and third audio-visual device 410c to operate on substantially the same time-base relative to each other and with very accurate timing control and timing resolution. According to the implementation of exemplary wireless network 402 shown in FIG. 1, group owner first audio-visual device 410a can provide timing and/or phase synchronization for client second and third audio-visual devices 410b and 410c. For example, group owner first audio-visual device 410a may track and take into account the overall delay and jitter in wireless network 402, and may run a closed loop time and phase lock tracking function to provide synchronization between first audio-visual device 410a, second audio-visual device 410b, and third audio-visual device 410c.

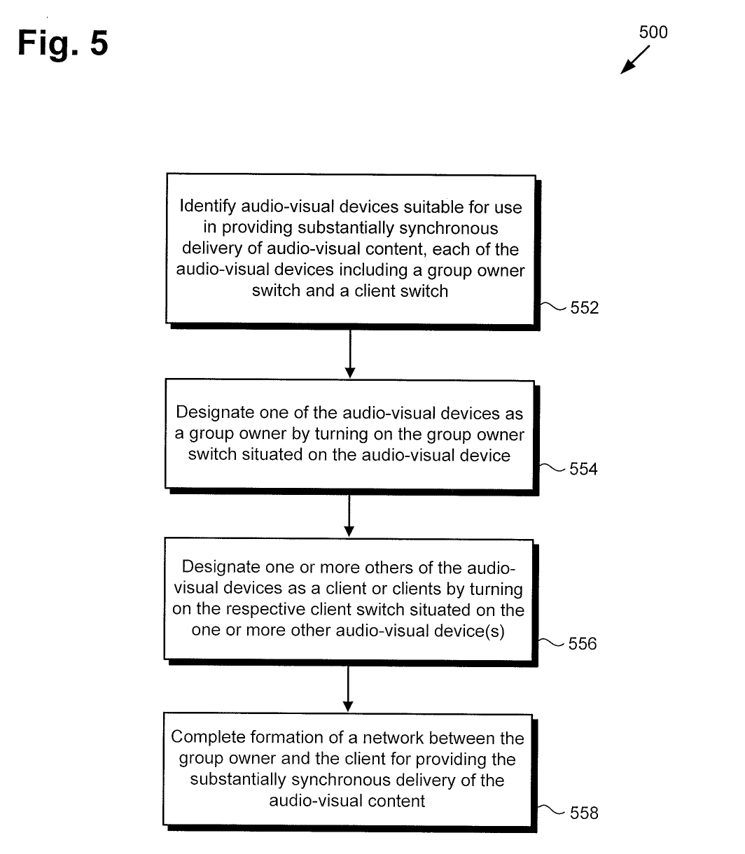

FIG. 5 shows flowchart 500 presenting an exemplary method for networking one-touch configurable audio-visual devices. It is noted that certain details and features have been left out of flowchart 500 that are apparent to a person of ordinary skill in the art, in order not to obscure the discussion of the inventive features in the present application. It is further noted that although the actions outlined in flowchart 500 are described below by reference to the specific wireless network architecture shown in FIG. 4, the present method may also be performed using either of the wireless networks shown in FIGS. 1 and 3.

Flowchart 500 starts with identifying audio-visual devices suitable for use in providing a substantially synchronous delivery of audio-visual content, where each of the audio-visual devices includes a group owner switch and a client switch (action 552). Referring to FIGS. 2A, 2B, and 4, for example, first audio-visual device 210a /410a including group owner switch 212a and client switch 212b may be identified for use in forming wireless network 402. In addition, audio-visual device 210b/c corresponding to second and third audio-visual devices 410b and 410c and including group owner switch 212b/c and client switch 214b/c may also be identified for use in forming wireless network 402. As noted above, wireless network 402 including first audio-visual device 410a, second audio-visual device 410b, and third audio-visual device 410c is configured for substantially synchronous delivery of audio-visual content 406 to a user or users of wireless network 402.

Flowchart 500 continues with designating one of first audio-visual device 410a, second audio-visual device 410b, and third audio-visual device 410c as a group owner by turning on a respective group owner switch situated on one of first audio-visual device 410a, second audio-visual device 410b, and third audio-visual device 410c (action 554). Referring to FIG. 2A, first audio-visual device 210a corresponding to first audio-visual device 410a can be designated as a group owner by turning on group owner switch 212a situated on first audio-visual device 210a.

As discussed above, group owner switch 212a may be implemented as a toggle switch, or as a button, such as a push button, to name a few examples. As further discussed above, in some implementations, group owner switch 212a may be turned on using touchscreen 216a of first audio-visual device 210a, or using remote control 218. It is reiterated that, although first audio-visual device 410a is designated as the group owner of wireless network 402 in the exemplary implementation shown in FIG. 4, in other implementations, either of second audio-visual device 410b or third audio-visual device 410c corresponding to audio-visual device 210b/c having group owner switch 212b/c can be designated as the group owner, rather than first audio-visual device 410a.

Flowchart 500 continues with designating one or more others of first audio-visual device 410a, second audio-visual device 410b, and third audio-visual device 410c as a client by turning on a respective client switch situated on first audio-visual device 410a, second audio-visual device 410b, and third audio-visual device 410c (556). Referring to FIG. 2B, audio-visual device 210b/c corresponding to either or both of second audio-visual device 410b and third audio-visual device 410c can be designated as a client by turning on client switch 214b/c situated on audio-visual device 210b/c.

As discussed above, client switch 212b/c, like group owner switch 212a or group owner switch 212b/c, may be implemented as a toggle switch, or as a button, such as a push button, for example. As further discussed above, in some implementations, client switch 212b/c may be turned on using touchscreen 216b/c of audio-visual device 210b/c, or using remote control 218.

Although second audio-visual device 410b and third audio-visual device 410c are designated as clients of wireless network 402 in the implementation shown in FIG. 4, that representation is merely by way of example. In other implementations, either of second audio-visual device 410b or third audio-visual device 410c corresponding to audio-visual device 210b/c having group owner switch 212b/c can be designated as the group owner, while the other of second audio-visual device 410b or third audio-visual device 410c and/or first audio-visual device 410a, each of which includes a client switch, can be designated as a client or clients.

It is noted that in some implementations, turning on group owner switch 212a or 212b/c commands respective first audio-visual device 210a or audio-visual device 210b/c to share its network credentials with other audio-visual devices identified for use in forming the network, such as wireless network 402. However, in other implementations, first audio-visual device 210a and audio-visual device 210b/c may include a distinct share button (not shown in FIGS. 2A or 2B) that may be turned on after group owner switch 212a or 212b/c is turned on, thereby causing first audio-visual device 210a or audio-visual device 210b/c to share its network credentials with the other audio-visual devices identified for use in forming the network.

It is further noted that in some implementations, turning on client switch 214a or 214b/c commands respective first audio-visual device 210a or audio-visual device 210b/c to pair with a group owner. However, in other implementations, first audio-visual device 210a and audio-visual device 210b/c may also include a distinct pair button (not shown in FIGS. 2A or 2B) that may be turned on after client switch 214a or 214b/c is turned on, thereby causing first audio-visual device 210a or audio-visual device 210b/c to pair with the audio-visual device designated as group owner. In either use case, and in contrast to conventional WPS protocols, according to the present inventive principles, a group owner audio-visual device can advantageously pair or otherwise connect with two or more client audio-visual devices substantially concurrently.

Flowchart 500 can conclude with completing formation of a network between the group owner and the one or more client(s) for substantially synchronously delivering the audio-visual content (action 558). Referring to FIG. 4, completing formation of wireless network 402 includes establishing all wireless communication links between group owner first audio-visual device 410a and client second and third audio-visual devices 410b and 410c. According to the exemplary implementation of FIG. 4, those wireless communication links include wireless communication links 422, 424, and 426 mediated by router 420, and direct wireless communication links 432 and 434 between group owner first audio-visual device 410a and respective client second and third audio-visual devices 410b and 410c.

As noted above, in some applications, such as network media and audio streaming applications, for example, it may be advantageous or desirable for first audio-visual device 410a, second audio-visual device 410b, and third audio-visual device 410c to operate on substantially the same time-base relative to each other and with very accurate timing control and timing resolution. Thus, group owner first audio-visual device 410a may be configured to provide timing and/or phase synchronization for client second and third audio-visual devices 410b and 410c. For example, and as further noted above, group owner first audio-visual device 410a may track and take into account the overall delay and jitter in wireless network 402, and may run a closed loop time and phase lock tracking function to provide synchronization between first audio-visual device 410a, second audio-visual device 410b, and third audio-visual device 410c.

There are several methods and protocols for maintaining accurate time and phase synchronization between group owner first audio-visual device 410a and client second and third audio-visual devices 410b and 410c, and one or several of such methods or protocols may be used in wireless network 402, depending on the application requirements. Time and phase synchronization protocols may operate through the infrastructure network provided by router 420, i.e., over wireless communication links 422, 424, and 426, or over direct wireless communication links 432 and 434.

Use of direct wireless communication links 432 and 434, rather than wireless communication links 422, 424, and 426 provided by router 420, to perform such routing improves the accuracy of time synchronization protocols because the delays and jitter introduced by router 420 can be avoided. Router 420 typically introduces delays and jitter into network traffic that negatively impact the accuracy and stability of synchronization algorithms and protocols. As a result, the performance of wireless network 402 can be significantly better, due to use of direct wireless communication links 432 and 434 for routing, than the performance of a time and phase synchronized network based on the infrastructure provided by router 420 alone.

For example, in implementations in which first audio-visual device 410a, second audio-visual device 410b, and third audio-visual device 410c are audio speakers, the audio latency resulting from use of direct wireless communication links 432 and 434 for routing of control data and audio-visual content 406 may be as little as approximately twenty milliseconds (20 ms), when exclusive reliance on router 420 for such routing may deliver one to two seconds of audio latency for the same use case and application.

Thus, the present application discloses networked one-touch configurable audio-visual devices, and methods for networking such one-touch configurable audio-visual devices to provide substantially synchronous delivery of audio-visual content. The various networked one-touch configurable audio-visual devices and the networking methods disclosed in the present application advantageously enable a user to establish and enjoy a multi-room home network without needing or mastering a complicated network setup software application (e.g., an “app”).

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

1. A method for networking audio-visual devices for substantially synchronous delivery of audio-visual content, each of said audio-visual devices having situated thereon a respective group owner switch and a respective client switch, said method comprising:
designating one of said audio-visual devices as a group owner by turning on a respective group owner switch situated on said one of said audio-visual device;
designating at least another one of said audio-visual devices as a client by turning on a respective client switch situated on said at least another one of said audio-visual devices, thereby fonning a network between said group owner and said client for said substantially synchronous delivery of said audio-visual content.

2. The method of claim 1, wherein designating at least another one of said audio-visual devices as a client comprises designating two or more of said audio-visual devices as two or more clients by turning on their respective client switches, thereby forming a network between said group owner and said two or more clients for said substantially synchronous delivery of said audio-visual content.

3. The method of claim 1, wherein said audio-visual devices are audio speakers.

4. The method of claim 1, wherein each of said respective group owner switch and said respective client switch is a push button.

5. The method of claim 1, wherein each of said respective group owner switch and said respective client switch is turned on using a touchscreen.

6. The method of claim 1, wherein each of said respective group owner switch and said respective client switch is turned on using a remote control.

7. The method of claim 1, further comprising receiving via one of a wireless connection and a wire connection, by said group owner, said audio-visual content from an external data source.

8. The method of claim 1, further comprising utilizing a router to route said audio-visual content from said group owner to said client.

9. The method of claim 1, wherein said network between said group owner and said client is formed via a direct wireless connection between said group owner and said client.

10. The method of claim 9, wherein said direct wireless connection between said group owner and said client is via at least one of WiFi, Bluetooth, ZigBee, and 60 GHz wireless communications methods.

11. A network of audio-visual devices for substantially synchronous delivery of audio-visual content, said network comprising:
each of said audio-visual devices having situated thereon a respective group owner switch and a respective client switch;
each of said audio-visual devices being configured to be designated as a group owner by turning on said respective group owner switch situated on each of said audio-visual devices;
each of said audio-visual devices being configured to be designated as a client by turning on said respective client switch situated on each of said audio-visual devices;
wherein said network between said group owner and said client for said substantially synchronous delivery of said audio-visual content is formed when said respective group owner switch and said respective client switch are turned on.

12. The network of claim 11, wherein said audio-visual devices are audio speakers.

13. The network of claim 11, wherein each of said respective group owner switch and said respective client switch is a push button.

14. The network of claim 11, wherein each of said respective group owner switch and said respective client switch is turned on using a touchscreen.

15. The network of claim 11, wherein each of said respective group owner switch and said respective client switch is turned on using a remote control.

16. The network of claim 11, wherein said group owner is configured to receive said audio-visual content via a wireless connection from an external data source.

17. The network of claim 11, wherein said group owner is configured to receive said audio-visual content via a wire connection from an external data source.

18. The network of claim 11, further comprising a router for routing said audio-visual content from said group owner to said client.

19. The network of claim 11, wherein said network between said group owner and said client is formed via a direct wireless connection between said group owner and said client.

20. The network of claim 19, wherein said direct wireless connection between said group owner and said client is via at least one of WiFi, Bluetooth, ZigBee, and 60 GHz wireless communications methods.
